(19) United States
(12) Patent Application Publication
(10) Pub. No.: US 2021/0311607 A1
(43) Pub. Date: Oct. 7, 2021

(54) LOCATION-BASED INTERACTIVE GRAPHICAL INTERFACE DEVICE

(71) Applicant: WGames Incorporated, Toronto (CA)

(72) Inventors: Daniel KAJOUIE, Toronto (CA); Tomasz DYSINSKI, Toronto (CA)

(21) Appl. No.: 16/973,528

(22) PCT Filed: Jun. 12, 2019
(86) PCT No.: PCT/CA2019/000089

§ 371 Date: Dec. 9, 2020

Related U.S. Application Data
(60) Provisional application No. 62/683,862, filed on Jun. 12, 2018.

(51) Int. Cl. G06F 3/0481; G06F 3/0488; A63F 13/2145; A63F 13/5378

(52) U.S. Cl. CPC G06F 3/04815; A63F 13/5378; A63F 13/2145; G06F 3/0488

(57) ABSTRACT

An interface controller (10, 111) configured to enable a user of a touchscreen (20) or other interactive device (906) to identify and selectively invoke one or more data processes allows the user to interact with an arbitrary number of processes, such as gaining options, in a multi-dimensional virtual world (100), based on any of a very wide variety of parameters, including the user's geographical location, gaining history, stated preferences, observed performance, and availability of new and old games. Gaming options can be presented in personalized sequences and combinations.

### CROSS-REFERENCE TO RELATED APPLICATION

This application claims all benefit, including priority, of U.S. Provisional Patent Application Ser. No. 62/683,862, filed 12 Jun. 2018 and entitled Multi-Process Interface Controller, the entire contents of which are incorporated herein by this reference.

### FIELD OF THE INVENTION

The present disclosure relates to improved electronic interface controllers for data processors, and more particularly to interface controllers configured to enable a user of a touchscreen or other interactive device to identify and selectively invoke one or more data processing applications controllable by the interactive device.

### BACKGROUND OF THE INVENTION

Users of systems for enabling data processors such as smart phones, desktop computers, and other personal digital assistants sometimes wish to access large number of choices of data processes, such as games, that are of one or more types or classes, and to do so rapidly and efficiently. Current systems are open to improvements, as they are too often slow and inefficient.

### SUMMARY OF THE INVENTION

An interface controller configured to enable a user of a touchscreen or other interactive device to identify and selectively invoke one or more data processes allows the user to interact with an arbitrary number of processes, such as gaming options, in a multi-dimensional virtual world, based on any of a very wide variety of parameters, including the user's geographical location, gaming history, stated preferences, observed performance, and availability of new and old games. Gaming options can be presented in personalized sequences and combinations.

In various aspects, the present disclosure provides devices, systems, devices, persistently-stored, machine-interpretable programming and/or other data products for enabling rapid, secure, and efficient access by users of network communication devices and controllers to arbitrary numbers and personalized sequences of various types and categories of smart phone, computer, and other types of data processing applications and programs, including games and a wide variety of other products.

For example, in various aspects and embodiments the invention provides multi-process interface controller, such a controller comprising one or more data processors; one or more touchscreen input/output devices; and one or more network communication systems, and the at least one data processor is configured to generate, in accordance with command signals received from the at least one input device and logical rules associated with a multi-process access control application of the multi-process interface controller, a list processes request command data set and, using the at least one network communication system, route the list processes request command data set to a multi-process host system. The controller can further can be configured to receive from the same or another multi-process host system via the same or another network communication system and in response to the list processes request command data set, an available process list data set comprising data representing a listing of games or other processes. In accordance with logical rules associated with the same or another control application the controller can generate display command signals useful for generating and displaying a graphical representation of at least a portion of a highest level of at least a three-dimensional map, said highest-level portion comprising when displayed interactive graphical devices associated with executable instructions configured, when selected by a user of the controller, to cause the at least one processor to generate display command signals useful for generating and displaying a graphical representation of at least a portion etc., of a lower level of the least three-dimensional map; said lower-level portion comprising when displayed interactive graphical devices associated with executable instructions configured, when selected by a user of the controller, to cause the at least one processor to generate signals representing a process initiation command, the process initiation command configured to cause the same or other multi-process host system to execute a data process associated with the same or other control application; and using the at least one network communication system, route the signals representing the process initiation command to the same or other multi-process host system.

In further aspects and embodiments the multi-process interface controller can include a positioning device configured to generate signals representing a current geographical position of the controller wherein one or more features of the at least three-dimensional map are generated at least partly based on said position.

In the same and other embodiments, the multi-process interface controller can be configured, subsequent to display of at least a first portion of said three-dimensional map, begin generation of data representing at least one adjacent portion etc., of said at least three-dimensional map, and store said data representing at least an adjacent portion of said three dimensional map in a cache associated with the at least one touchscreen input/output device.

In further aspects and embodiments, the invention provides persistent machine-interpretable media comprising data representing instructions for causing at least one processor of a multi-process interface controller to perform such processes.

The invention further provides corresponding processes.

### BRIEF DESCRIPTION OF THE DRAWINGS

Various aspects and embodiments of the invention are illustrated in the accompanying drawings, which are meant to be exemplary and not limiting, and in which like references are intended to refer to like or corresponding parts.

FIGS. 1 and 2 are schematic diagrams showing embodiments of and aspects of multi-process interface controllers in accordance with the invention.

FIG. 3 is a schematic diagram illustrating an example of inter-device communication processes in accordance with embodiments of some aspects of the invention.

FIGS. 4-8 are schematic diagrams showing concepts and logical relationships pertinent to further aspects of multi-process interface controllers in accordance the invention.

### DESCRIPTION OF EMBODIMENTS

In various aspects and embodiments, the invention provides improved electronic interface controllers for data processors, including particularly interface controllers configured to enable a user of a touchscreen or other interactive device to identify and selectively invoke one or more data processing applications controlled by the interactive device. The invention also provides related processes and programming products.

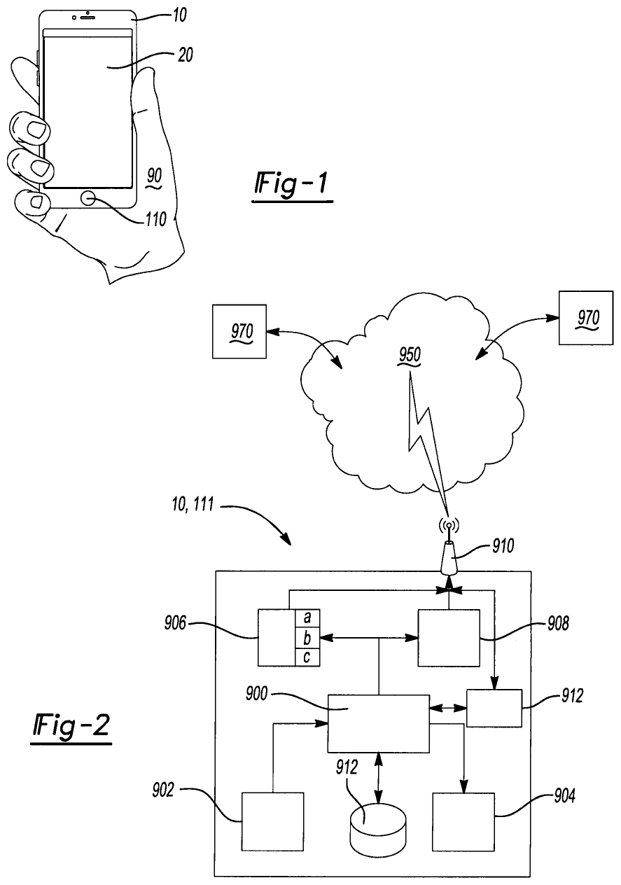

FIGS. 1 and 2 are schematic diagrams showing embodiments of aspects of a multi-process interface controller 10, 111 in accordance with the invention. In the embodiment shown, a multi-process interface controller 10 comprises a wireless or other network communication device 111 configured to enable a user 90 of a touchscreen 20 or other interactive device 906 to identify and selectively invoke one or more data processes (games) in accordance with the disclosure shown. In the embodiment shown, the controller 10 includes at least one or more data processors 900, one or more touchscreens 20 and/or other graphical displays and input devices 906, physical keyboard(s) and/or virtual keyboard application(s) or drivers 904, and one or more wireless or wireline communication systems 908 for communicating electronic data signals via one or more networks 950 such as the internet and/or public switched telephone network (PSTN).

As will be understood by those skilled in the relevant arts, once they have been made familiar with this disclosure, controllers 10,111 in accordance with the invention can be implemented using a very wide variety of devices, including for example general- or special purpose data processing systems such as smart phones, laptop and/or tablet computers or other personal digital assistants, desktop of other stationary processing systems, etc. In addition to the (sub)systems described above, such controllers can further comprise one or more positioning systems, such as global positioning systems (GPSs) 912, data memories 912 and any number of programming memories or structures 902, comprising machine-interpretable instructions configured for execution by processor(s) 900 in order to implement operating systems and general or special purpose executable programming applications, such as applications configured to initiate and control processes such as games executed by the processor(s) 900 and/or, via communication system(s) 908, and network 950, by systems or devices 970 remote from the controller 10, 111.

Positioning system(s) 912 can comprise any location-identifying systems suitable for use in accordance with the purposes disclosed herein. For example, GPSs and other systems capable of providing very precise information will serve, as will systems providing less precise information, such as cellular telephone local cell identification systems, radio-frequency identification devices (RFIDs) and other near-field or low range radio-based devices, and/or inertial systems.

Memory(ies) 912 can comprise any media suitable for enabling access by processor(s) 900 to data temporarily or persistently stored therein, including for example one or more of any or all of registers, buffers, caches, random-access memories (RAMs), read-only memories or firmware, flash drives, disk drives, etc., including registers, buffers, caches, RAMs and/or ROMs that may be physically and/or virtually separated for speed and efficiency in processing of operations described herein.

Such configurations can, for example, enable a user 90 of a device 10, 111 to access and initiate or otherwise invoke one or more of any number of data processes such as online games or other applications by using a specialized (e.g., gaming) app or general-purpose network browser to navigate via one or more networks 950 to a gaming server or other online program host site 970, and thereafter selecting an ‘access games’ item such as a graphical icon 102 on a touchscreen 20.

Moreover, users 90 are enabled to interact with unique, engaging, and attractive personalized, and personalize-able, virtual worlds.

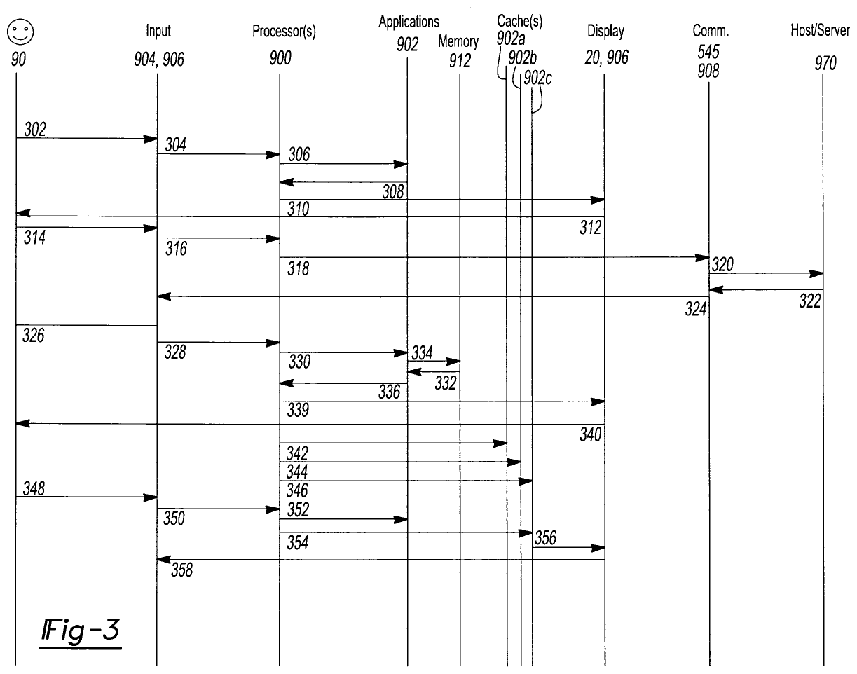

For example, as shown at 302, 304, 306 in FIG. 3, a user 90 of such a device 10, 111 can use either or both of a physical or virtual keyboard 104, 904 and an interactive application icon 102 and touchscreen 20, 906, to interact with processor(s) 900 in order to generate a set of command signals configured to invoke a gaming application stored in memory 902. At 308, invocation of a gaming or other application 902 can for example cause logical instructions of the application 902 to cause processor(s) 900 to generate a ‘list games’ or other ‘list processes’ request, which can for example include signals representing at least the following data items:
<gaming server address><requesting user identifier><game list request flag><user's actual or preferred location>
   where:
<gaming server address>=network resource identifier associated with a gaming or other application host or server 970 associated with the application 102, 902;
<requesting user identifier>=network resource or other identifiers associated with either or both of user 90 and device 10, 111; and
<game list request flag>=flag or other data set indicating a request for routing of a list of games or other processes available to the user, e.g., based on a user's prior registration or subscription.
<user's actual or preferred location>=coordinates or other indicators associated with an actual or fantasy location of the user. Such location can be provided by a positioning system 912, by a user through a drop down menu or selection from other list, and/or designation, by means of a touchscreen 20, pointing device, or other mechanism of a location in a virtual world provided by the application 902 or server 970

A user 90's location can be set using any of the following criteria is enabled to select his/her location,
The user 90's actual, physical location, as determined by a GPS or other positioning device 912 of the user's device 10, 111
A user's preferred actual, imaginary, or virtual location
Popularity of locations among current or historical sets of users 90
The user 90's history of game playing
The user 90's skill level, actual or predicted
Terms associated with the user 90's subscription

At 310-316, the processor(s) 900 can optionally request confirmation from the user 90 that he/she wishes the list games request be routed to the host or server 970 by routing, at 310, a confirmation request signal set to the display 20, 906; whereupon at 314 the user 90 can generate a confirmation data set by interacting with input device(s) 904, 906 and at 316 causing the confirmation data set to be returned to the processor(s) 900.

Processor(s) 900 can cause the (optionally confirmed) list games request to be routed to the desired server 970 by, at 418, routing the list games request data set to communication device(s) 908, which at 420 can format the data in accordance with a desired network communications protocol and route it to the intended host or server 970.

On receipt of signals representing the ‘list games’ or other list request data set, at 322 the gaming server 970 can return an available process list data set representing a listing of games or other processes. The listing can include any desired number of gaming or other processing choices, depending for example upon authorizations granted by the server 970 to a user 90 associated with the requesting user identifier provided in the list request data set, the user 90's preferences, and/or any technical or strategic preference of the operator(s) of the server 970.

For example, any or all a very wide variety of criteria can be used by the server 970 and/or application 902 to assemble a list of games to be made available to the user 90, and/or to associate each of the identified games with one or more real or imagined geographic locations. Examples of criteria useful for identification of games to be made available to the requesting user can include:
List all games currently available
Newness or current popularity of games, or trends therein, with respect to the user or larger pools or groups of users
The user's history of game playing, including skills levels and win/loss history
Data and/or conclusions based thereon relating to a user's actual or predicted skill in playing games, or types of games
Predicted current or future preferences of the user
The user's current and past subscription terms with the gaming service
The user's stated preferences for gaming and/or other activities
The user's geographic or virtual location, past, present, or predicted, whether real or imaginary

When one or more games have been identified for use in responding to the request, at 322, 324 the gaming server 970 can return to the user's device or gaming app all or any portion of the listing via any suitable communication system 908 associated with the user 90's device 10, 111. Listings might be returned in portions where, for example as described below, a user 90 has navigated to a map or globe section showing only a portion of geography accessible to the user, so that corresponding map displays can be generated and displayed rapidly and efficiently.

Listings returned at 324 can include arbitrarily large numbers of gaming choices. The returned ‘game list’ data set can for example include:
<user device address><gaming server identifier>
<game listing: G1,L1; G2,L2; G3,L3 . . . GN,LN>
   where the game listing includes identifiers Gᵢ associated with each of an arbitrary number of games, each associated with a geographic location Lᵢ. Locations Lᵢ can be identified in any desired real or virtual absolute or relative terms.

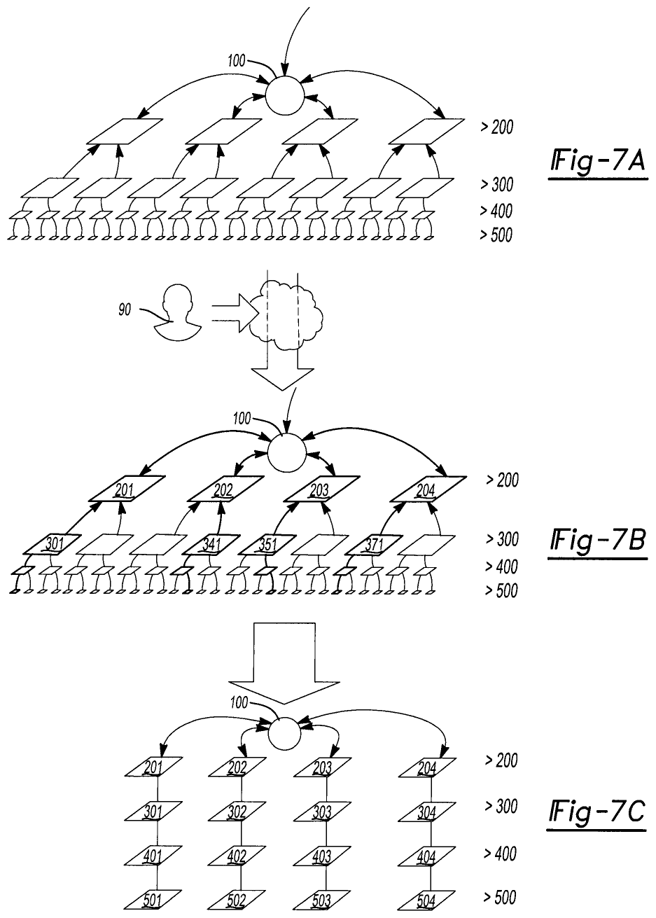

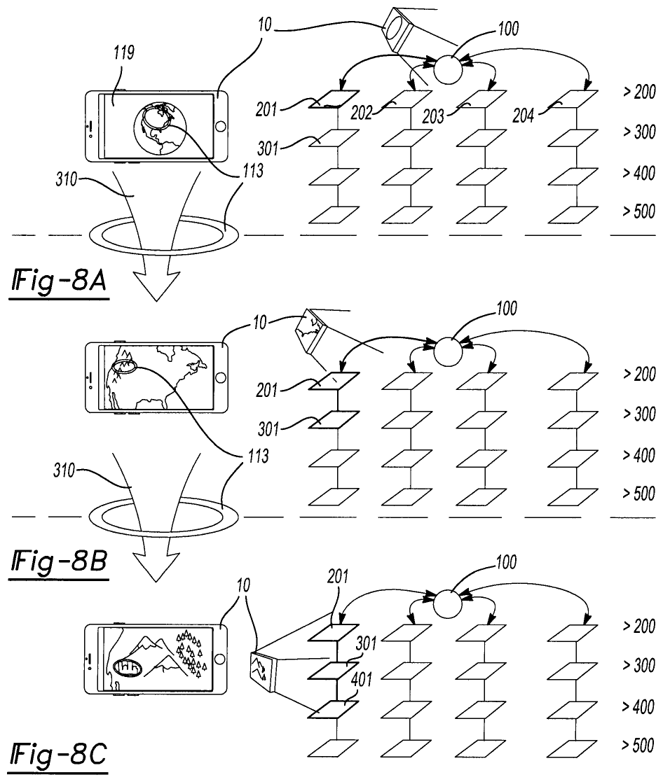

On receipt of the game listing, at 326 either or both of the user's gaming app 902 and the gaming server 970 that provided the listing can generate data representing a multi-dimensional interactive map 100 adapted to enable the user 90 to navigate through one or more levels of resolution (map ‘zoom’ levels) 200, 300, 400, etc. (see e.g. FIGS. 7 and 8), to one or more locations or regions 110, 113, 120. 130 on the map and view, and optionally select for playing one or more of the games provided in the listing, which may be shown in any desired format(s).

Features of the interactive map interface, and generation thererof, are described below, with reference to the various Figures.

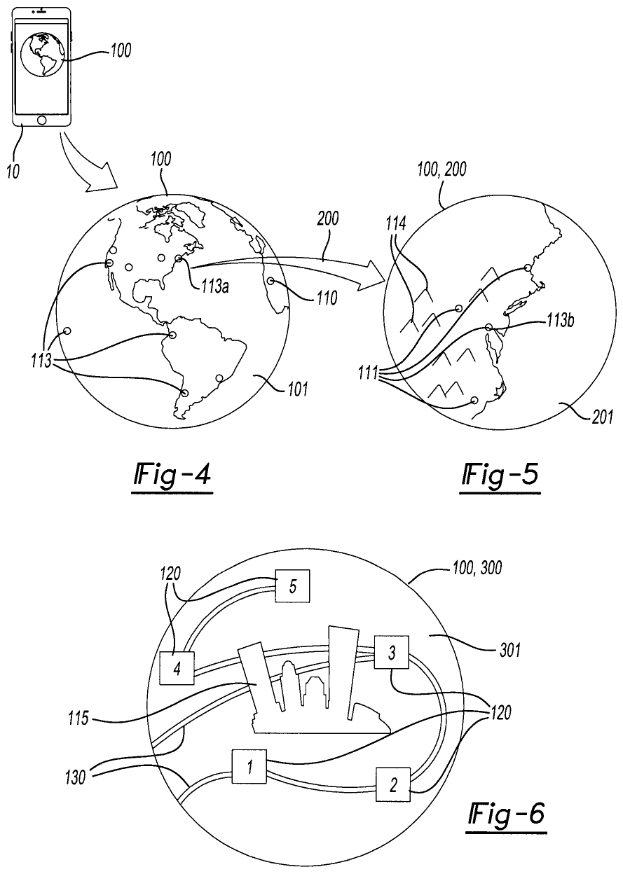

Generation and/or navigation of a multi-dimensional virtual map 100 can begin with or at any location within the map set or desired by any or all of the user 90, the user's gaming app 902, and/or a corresponding gaming server 970. As shown in FIGS. 4 and 7, for example, on invoking a gaming app 902 a user's device 10, 111 can be caused to display a virtual globe 100 representing a real or imaginary geography. The virtual globe 100 can be presented in any desired initial orientation; for example a user located or having a special interest in Mexico City, or anywhere else in the Western Hemisphere, can be presented an image centered on all or any part of the Western Hemisphere.

Using multi-dimensional imaging and scrolling techniques, the user 90 can be enabled to rotate or otherwise manipulate the map/globe 100 so that any desired portion of the map/globe is presented. For example, the user 90 can place her/his finger on an image of the globe 100 on a touchscreen 20, and “rotate” the image by moving his/her finger on the screen, so that the point of the globe covered by finger moves with the finger tip, thus causing other portions of the to appear to rotate into and out of the view presented. Alternatively, or in addition, a user may touch a portion of the virtual map associated with more-detailed views, in order to ‘zoom’ the map to the desired location (see for example FIGS. 8A-8C.

Various types of interactive interface (GUI) devices 113 can be overlaid upon, incorporated within, or otherwise presented in association with representations of various specific location(s) on the map/globe 100. Such GUI devices can, for example, include items associated with ‘zoom’ commands which, when selected, cause the user device 10 to generate and display an expanded-scale mapping of the globe/map 100, or a portion thereof, with the same or additional devices or types of 113 displayed.

For example, ‘zoom’ features 113 can be presented in the form of graphic images representing circles or ‘portals,’ through which, for example, a portion of a higher-resolution (e.g., ‘lower altitude’) map can be presented, and seen by the user 90; selection of such a feature 113 can cause the virtual map to zoom to show some or all of the features previously displayed within the portal, and optionally additional features, at the same or different resolutions. For example, as shown by arrows 200, 210, 310 and FIGS. 5 and 8A-8C, selection of a ‘portal’ item 113a can cause the user's device to generate and display a series of images representing movement toward and ‘descent’ through the portal to a lower ‘altitude’, showing an expanded view of a more localized region of the map or globe.

Optionally, the process of ‘zooming’ or ‘descending’ through such portal features 113 can include the display of animated sequences suggesting a process of transportation or descent, during the display of which the processors of either or both of the user device 10 and a gaming server 970 can generate and initiate display of the next or ‘lower’ level map, using painting or other image generation techniques, including for example painting, or building of images using standard image data blocks comprising data representing various types of two-dimensional or three-dimensional images of terrain, building etc.

As shown for example in FIG. 5, once the process of ‘descending’ through a portal feature 113 is complete, the user's device 10 can display an expanded view of a smaller region of the map or globe 100 previously displayed. For example, as shown in FIG. 6, a map of a metropolitan area 110a can be expanded to show a variety of portal features 115 corresponding to individual cities, with other geographic features and points of potential interest displayed as well, such as natural parks, mountains, etc 114.

As shown particularly in FIGS. 7 and 8, in order to facilitate the presentation of detailed and interesting maps including a variety of interesting interactive features 114, 115, etc., it can be advantageous to store permanently in memory(ies) 912 and caches 906a, 906b, 906c, etc., of the user 90's device 10, and/or on server(s) 970 only data representing specific map features, such as the names, locations, and chief features of cities or other points of interest, and to rely on processor(s) of device(s) 10 and/or gaming servers to generate and display (i.g., “paint”) relatively limited subsets of the entire globe or map accessible by the user 90. For example, as shown conceptually in FIG. 7B, when a user 90 wishes to navigate to a new map area, either by ‘ascending’ or ‘descending’ through portals 113, or by scrolling or otherwise navigating to map regions adjacent to those currently presented, map and feature data can be generated in the following sequence:
1. The next smaller-scale (“higher altitude”) or larger-scale (“lower altitude) region 202 to be displayed
2. Adjacent regions 201, 203, 204 at the same ‘zoom’ or altitude level 200
3. Adjacent regions 100, 341 at the next higher and next lower zoom levels 100, 300
4. Further surrounding areas adjacent to regions specified in steps 1-3 above

For example a user 90 of a controller 10, 111 viewing a map 100 such as that shown in FIG. 4 can select an interactive portal element 113a on a touchscreen 20 of his device 10 to navigate to a map such as that shown in FIG. 5. As the user dwells on the screen shown in FIG. 5 without selecting an interactive element 113, the responsible processor(s) 900 can generate data representing adjacent regions in the order named, as to eventually, if the user dwells long enough, filling in an entire map or map section as shown in FIGS. 7B and 7C. Upon receipt of a user command requesting navigation to any of the adjacent regions, the processors can suspend or terminate generation of adjacent areas, and initiate generation of areas adjacent to the newly-designated area, in the order indicated.

For example, at 326 in FIG. 2 a user 90 presented with a highest-level map image 101 selects an interactive portal item 113a on a touchscreen 20 of his device 10 to navigate to a second-level region 201 of the map 100. At 328, this causes a corresponding map navigation command to be routed to the processor(s) 900. Such a map navigation command can for example comprise data representing a location on the virtual map 100 corresponding to the point or region of the map touched by the user.

At 330-332, the processor(s) 900 can apply logical rules associated with the corresponding map application 902 to determine that the region touched by the user corresponds to a zoom portal 113, and for example by using table-lookup techniques, can access data stored in memory(ies) 912 and/or server(s) 970 representing a next-level image of portion 201 of the map 100 designated by the use, and at 334-336 can generate an image thereof for display by the touchscreen 20. As noted above, the data representing the section 201 can comprise references to pre-defined stock map elements, such as grass, woods, mountains, roads, buildings, seas, and lakes, associated with various identified locations on the map section. At 332-334 the processor(s) 900 can use such references to generate a map section image data set, and display it at 338 by routing it to a display register or buffer 906 associated with the touchscreen 20, resulting at 340 in a map display such as that shown at 201 in FIGS. 5 and 8B.

Once the data representing the map section 201 has been routed to the register at buffer of the display 906 at 338, the processor(s) 900 can apply logic associated with the application 102 to begin a process of generating image display data sets representing adjacent portions 202, 203, 204, etc. of the same-level map 200, and optionally portion 301 representing the next-zoom level region of the map 300 associated with the portion 201 currently displayed, as shown at FIG. 8a; and image data so generated can at 342, 344, 346 be routed buffers or caches 906a, 906b, etc., associated with the display 20, 906 for storage, rapid access, and display.

Thus, no matter which direction the user 90 may decide to navigate next, processing and display time for the next-selected region can be reduced.

For example, if at 348 in FIG. 3 the user 90 decides to navigate through portal 113b shown in FIG. 3 to portion 301 of the map 300, then by touching the portal icon 113b at that point on the screen 20 the user can cause a corresponding map navigation command to be routed to the processor(s) 900 at 350. When at 352 the command is applied to logic rules associated with the map application 902, a flag may be returned to the processor indicating that data representing the requested map image is ready in buffer(s) 906a, etc., and at 354 a corresponding command can be routed to the respective buffer 906a, and at 356 the data in the buffer can be processed by the display 906 and presented to the user 90.

Alternatively, if the user 90 decides to navigate to an adjacent portion 202 of the map at level 200, then by swiping her/his finger along the touchscreen 20 the user can cause a corresponding map navigation command to be routed to the processor(s) 900, and the processor can apply logic rules associated with the map application 902 to the command, so a command can be routed to the display 906 to access and display data representing the adjacent section 202 and already stored in a buffer 906b.

Among the items included embedded maps and map sections displayed at any of levels 200, 300, of map expansion or zoom can be features 120 configured to enable a user 90 to initiate either or both of the user's gaming app and/or the gaming server to initiate a game and allow the user 90 to participate. Such features 120 can, for example, include hypertext or other executable code configured to route suitably-configured commands to either or both of application 902 and host or sever 970.

Games represented and invoked by GUI devices 120 can include any desired type(s) of social games, games of chance, VLTs, virtual slots, role-playing games, etc. Games can be configured for individual play, tournaments, or other forms of multi-player participation.

Any or all of the identity of the games associated with the initiation features 120 displayed, the nature or characteristics of the initiation features 120, and/or other map features can be based on any of the criteria listed above, including historically-indicated and/or predicted user preferences.

Such preferences can also be used, as shown conceptually in FIG. 7B, to determine which subsets of a larger set of maps or images (also called a ‘superset’) are generated by either or both of a user's gaming app and a gaming server, or loaded onto the user's device at any time, in order to minimize or otherwise control amounts of data loaded or otherwise processed by the interactive interface at any time.

Among the novel features offered by access controllers according to this disclosure is the provision of interactive path elements 130, linking various games or groups of games in a wide variety of orders. The combination(s) of games presented, and the order in which they are presented, and the paths by which they are connected, can be personalized for individual users. Games can be selected and presented, for example, in accordance with the established or anticipated level of an individual's playing skill, based on historic or predicted user preferences, etc

Thus, in various aspects and embodiments the invention provides multi-process interface controllers 10, 111, such a controller comprising one or more data processors 900; one or more touchscreen input/output devices 906; and one or more network communication systems 908, and the at least one data processor 900 is configured to generate, in accordance with command signals received from the at least one input device 906 and logical rules associated with a multi-process access control application 902 of the multi-process interface controller, a list processes request command data set and, using the at least one network communication system 908, route the list processes request command data set to a multi-process host system 970. The controller 10, 111 can further can be configured to receive from the same or another multi-process host system 970, via the same or another network communication system and in response to the list processes request command data set, an available process list data set comprising data representing a listing of games or other processes. In accordance with logical rules associated with the same or another control application 902, the controller 10, 111, can generate display command signals useful for generating and displaying a graphical representation of at least a portion 101 of a highest level of at least a three-dimensional map 100, said highest-level portion 101 comprising when displayed interactive graphical devices 113 associated with executable instructions configured, when selected by a user of the controller, to cause the at least one processor to generate display command signals useful for generating and displaying a graphical representation of at least a portion 201, 301, etc., of a lower level 200, 300, 400, etc. of the least three-dimensional map 100; said lower-level portion comprising when displayed interactive graphical devices 120 associated with executable instructions configured, when selected by a user of the controller, to cause the at least one processor 900 to generate signals representing a process initiation command, the process initiation command configured to cause the same or other multi-process host system 970 to execute a data process associated with the same or other control application; and using the at least one network communication system 908, route the signals representing the process initiation command to the same or other multi-process host system 970.

In further aspects and embodiments the multi-process interface controller 10, 111 can include a position device 912 configured to generate signals representing a current geographical position of the controller 10, 111, wherein one or more features of the at least three-dimensional map are generated at least partly based on said position.

In the same and other embodiments, the multi-process interface controller 10, 111 can condition display of at least one of said interactive graphical devices 113, 115 associated with executable instructions in said lower-level portion upon a subscription associated with a user 90 of the controller.

In the same and other embodiments, the multi-process interface controller 10, 111 can condition display of at least one of said interactive graphical devices 113, 115 associated with executable instructions in said lower-level portion upon a skill level associated with a user 90 of the controller.

In the same and other embodiments, the multi-process interface controller 10, 111 can condition display of at least one of said interactive graphical devices 113, 115 associated with executable instructions in said lower-level portion upon one or more preferences indicated by a user 90 of the controller, for example through use of a user profile or preference data set generated by an application 902.

In the same and other embodiments, the multi-process interface controller 10, 111 can be configured, subsequent to display of at least a first portion of said three-dimensional map 100, begin generation of data representing at least one adjacent portion 202, 203, 301, etc., of said at least three-dimensional map 100, and store said data representing at least an adjacent portion of said three dimensional map in a cache 906a, 906b, 906c, etc., associated with the at least one touchscreen input/output device 906.

In further aspects and embodiments, the invention provides both volatile and persistent machine-interpretable media comprising data representing instructions for causing processor(s) 900 and other components of controller(s) 10, 111 to implement any and all of the described processes.

While the disclosure has been provided and illustrated in connection with specific, presently-preferred embodiments, many variations and modifications may be made without departing from the spirit and scope of the invention(s) disclosed herein. The disclosure and invention(s) are therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the invention is to be defined solely by the appended claims, giving due consideration to the doctrine of equivalents and related doctrines.

What is claimed is:

1. A multi-process interface controller, comprising:
at least one data processor;
at least one touchscreen input/output device; and
at least one network communication system;
wherein the at least one data processor is configured to:
in accordance with command signals received from the at least one input device and logical rules associated with a multi-process access control application of the multi-process interface controller, generate a list processes request command data set;
using the at least one network communication system, route the list processes request command data set to a multi-process host system;
receive from the same or another multi-process host system, via the same or another network communication system and in response to the list processes request command data set, an available process list data set comprising data representing a listing of games or other processes;
in accordance with logical rules associated with the same or another control application, generate display command signals useful for generating and displaying a graphical representation of at least a portion of a highest level of at least a three-dimensional map, said highest-level portion comprising when displayed interactive graphical devices associated with executable instructions configured, when selected by a user of the controller, to cause the at least one processor to generate display command signals useful for generating and displaying a graphical representation of at least a portion of a lower level of the least three-dimensional map;
said lower-level portion comprising when displayed interactive graphical devices associated with executable instructions configured, when selected by a user of the controller, to cause the at least one processor to generate signals representing a process initiation command, the process initiation command configured to cause the same or other multi-process host system to execute a data process associated with the same or other control application; and
using the at least one network communication system, route the signals representing the process initiation command to the same or other multi-process host system.

2. The multi-process interface controller of claim 1, comprising a position device configured to generate signals representing a current geographical position of the controller, wherein one or more features of the at least three-dimensional map are generated at least partly based on said position.

3. The multi-process interface controller of claim 1, wherein display of at least one of said interactive graphical devices associated with executable instructions in said lower-level portion is conditioned upon a subscription associated with a user of the controller.

4. The multi-process interface controller of claim 1, wherein display of at least one of said interactive graphical devices associated with executable instructions in said lower-level portion is conditioned upon a skill level associated with a user of the controller.

5. The multi-process interface controller of claim 1, wherein display of at least one of said interactive graphical devices associated with executable instructions in said lower-level portion is conditioned upon a preference indicated by a user of the controller.

6. The multi-process interface controller of claim 1, wherein the at least one data processor is configured to:
subsequent to display of at least a first portion of said three-dimensional map, begin generation of data representing at least one adjacent portion of said at least three-dimensional map, and
storing said data representing at least an adjacent portion of said three dimensional map in a cache associated with the at least one touchscreen input/output device.

7. The multi-process interface controller of claim 6, wherein the adjacent portion of said three dimensional map is on a different level of said at least three-dimensional map.

8. Persistent machine-interpretable media comprising data representing instructions for causing at least one processor of a multi-process interface controller to:
in accordance with command signals received from the at least one input device and logical rules associated with a multi-process access control application of the multi-process interface controller, generate a list processes request command data set;
using the at least one network communication system, route the list processes request command data set to a multi-process host system;
receive from the same or another multi-process host system, via the same or another network communication system and in response to the list processes request command data set, an available process list data set comprising data representing a listing of games or other processes;
in accordance with logical rules associated with the same or another control application, generate display command signals useful for generating and displaying a graphical representation of at least a portion of a highest level of at least a three-dimensional map, said highest-level portion comprising when displayed interactive graphical devices associated with executable instructions configured, when selected by a user of the controller, to cause the at least one processor to generate display command signals useful for generating and displaying a graphical representation of at least a portion of a lower level of the least three-dimensional map;
said lower-level portion comprising when displayed interactive graphical devices associated with executable instructions configured, when selected by a user of the controller, to cause the at least one processor to generate signals representing a process initiation command, the process initiation command configured to cause the same or other multi-process host system to execute a data process associated with the same or other control application; and
using the at least one network communication system, route the signals representing the process initiation command to the same or other multi-process host system.

9. The persistent machine-interpretable media of claim 8, wherein the at least one processor is configured to generate signals representing a current geographical position of the controller, using at least signals provided by a positioning device of the controller, wherein one or more features of the at least three-dimensional map are generated at least partly based on said position.

10. The persistent machine-interpretable media of claim 8, wherein display of at least one of said interactive graphical devices associated with executable instructions in said lower-level portion is conditioned upon a subscription associated with a user of the controller.

11. The persistent machine-interpretable media of claim 8, wherein display of at least one of said interactive graphical devices associated with executable instructions in said lower-level portion is conditioned upon a skill level associated with a user of the controller.

12. The persistent machine-interpretable media of claim 8, wherein display of at least one of said interactive graphical devices associated with executable instructions in said lower-level portion is conditioned upon a preference indicated by a user of the controller.

13. The persistent machine-interpretable media of claim 8, wherein the at least one data processor is configured to:
subsequent to display of at least a first portion of said three-dimensional map, begin generation of data representing at least one adjacent portion of said at least three-dimensional map, and
storing said data representing at least an adjacent portion of said three dimensional map in a cache associated with the at least one touchscreen input/output device.

14. The persistent machine-interpretable media of claim 8, wherein the adjacent portion of said three dimensional map is on a different level of said at least three-dimensional map.
